(19) United States
(12) Patent Application Publication
(10) Pub. No.: US 2025/0306771 A1
(43) Pub. Date: Oct. 2, 2025

(54) SYSTEMS AND METHODS FOR SELECTIVE DATA FLUSHING

(71) Applicant: Samsung Electronics Co., Ltd., Suwon-si (KR)

(72) Inventors: Changho Choi, San Jose, CA (US); Ramdas P. Kachare, Pleasanton, CA (US); Dongwan Zhao, San Jose, CA (US); Amir Beygi, San Jose, CA (US); Tinh Lac, Manteca, CA (US); Jimmy Lau, Santa Clara, CA (US)

(21) Appl. No.: 18/903,301

(22) Filed: Oct. 1, 2024

Related U.S. Application Data
(60) Provisional application No. 63/573,367, filed on Apr. 2, 2024.

(51) Int. Cl. G06F 3/06

(52) U.S. Cl. CPC G06F 3/0619; G06F 3/0604; G06F 3/0679

(57) ABSTRACT

Provided is a method for memory management, the method including receiving, by a memory device, a host command including first priority information associated with first data, the first data being associated with a first location of a non-volatile memory, storing, by the memory device, the first priority information in a priority table of the memory device, based on a flush request, accessing, by the memory device, the first priority information from the priority table, and based on the first priority information, writing, by the memory device, the first data from a volatile memory to the non-volatile memory.

### CROSS-REFERENCE TO RELATED APPLICATION(S)

This application claims priority to, and benefit of, U.S. Provisional Application Ser. No. 63/573,367 (“S&M FOR SELECTIVE DATA FLUSH LATENCY OPTIMIZATION OF CXL BASED PERSISTENT MEMORY”), filed on Apr. 2, 2024, the entire content of which is incorporated herein by reference.

### FIELD

Aspects of some embodiments of the present disclosure relate to systems and methods for computer memory management.

### BACKGROUND

In the field of computers, a computing system may include a host and one or more memory devices connected to (e.g., communicatively coupled to) the host. Such computing systems have become increasingly popular, in part, for allowing many different users to share the computing resources of the system. Memory requirements have increased over time as the number of users of such systems and the number and complexity of applications running on such systems have increased.

The present background section is intended to provide context only, and the disclosure of any embodiment or concept in this section does not constitute an admission that said embodiment or concept is prior art.

### SUMMARY

Aspects of some embodiments of the present disclosure are directed to computing systems with improved memory management.

According to some embodiments of the present disclosure, there is provided a method for memory management, the method including receiving, by a memory device, a host command including first priority information associated with first data, the first data being associated with a first location of a non-volatile memory, storing, by the memory device, the first priority information in a priority table of the memory device, based on a flush request, accessing, by the memory device, the first priority information from the priority table, and based on the first priority information, writing, by the memory device, the first data from a volatile memory to the non-volatile memory.

The memory device may include a host interface configured to receive the host command from a host via a first protocol, and the host command may include first location information for identifying the first location of the non-volatile memory.

The method may further include receiving, by the memory device, the flush request based on a power event.

The memory device may include a cache controller for initiating, based on the flush request, flushing operations according to priority levels in the priority table.

The method may further include based on the flush request, accessing, by the memory device, address information associated with the first priority information.

The priority table may include second priority information associated with second data, the second data being associated with a second location of the non-volatile memory, the second priority information being different from the first priority information, and the method may further include, based on at least one of the first priority information or the second priority information, determining a relative order for writing the first data and the second data from the volatile memory to the non-volatile memory.

The method may further include receiving, by a first queue associated with a first priority level, a first device command associated with writing the first data from the volatile memory to the non-volatile memory, and receiving, by a second queue associated with a second priority level, a second device command associated with writing second data from the volatile memory to the non-volatile memory.

The first queue and the second queue may be associated with at least one of a priority scheme or an arbitration scheme configured by software.

The memory device may prioritize the writing of the first data over writing second data from the volatile memory to the non-volatile memory based on the first data being associated with a higher priority level than the second data.

The priority table may include confidence level information that is determined based on an energy level associated with the memory device.

The confidence level information may be determined based on an amount of energy that is consumed for storing the first data to the non-volatile memory, and the first priority information may be determined based on the confidence level information.

According to some other embodiments of the present disclosure, there is provided a memory device including a processing circuit configured to perform receiving a host command including first priority information associated with first data, the first data being associated with a first location of a non-volatile memory, storing the first priority information in a priority table of the memory device, based on a flush request, accessing the first priority information from the priority table, and based on the first priority information, writing the first data from a volatile memory to the non-volatile memory.

The memory device may further include a host interface configured to receive the host command from a host via a first protocol, the host command may include first location information for identifying the first location of the non-volatile memory.

The processing circuit may be configured to perform receiving, by the memory device, the flush request based on a power event.

The memory device may include a cache controller for initiating, based on the flush request, flushing operations according to priority levels in the priority table.

The processing circuit may be configured to perform, based on the flush request, accessing address information associated with the first priority information.

The priority table may include second priority information associated with second data, the second data may be associated with a second location of the non-volatile memory, the second priority information being different from the first priority information, and the processing circuit may be configured to perform, based on at least one of the first priority information or the second priority information, determining a relative order for writing the first data and the second data from the volatile memory to the non-volatile memory.

The processing circuit may be configured to perform receiving, by a first queue associated with a first priority level, a first device command associated with writing the first data from the volatile memory to the non-volatile memory, and receiving, by a second queue associated with a second priority level, a second device command associated with writing second data from the volatile memory to the non-volatile memory.

The first queue and the second queue may be associated with at least one of a priority scheme or an arbitration scheme configured by software.

According to some other embodiments of the present disclosure, there is provided a system including a volatile memory, a non-volatile memory, and a processing circuit configured to perform receiving a host command including first priority information associated with first data, the first data being associated with a first location of the non-volatile memory, storing the first priority information in a priority table of a memory device associated with the processing circuit, based on a flush request, accessing the first priority information from the priority table, and based on the first priority information, writing the first data from the volatile memory to the non-volatile memory.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a block diagram depicting a system for memory management, according to some embodiments of the present disclosure.

FIG. 2 is a table depicting a priority table for use in the system for memory management, according to some embodiments of the present disclosure.

FIG. 3 is a block diagram depicting a system for memory management including a storage device that is separated from a memory device of the system, according to some embodiments of the present disclosure.

FIG. 4 is a block diagram depicting a system for memory management including an integrated storage and memory device, according to some embodiments of the present disclosure.

FIG. 5 is a flowchart depicting operations of a method for memory management, according to some embodiments of the present disclosure.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

### DETAILED DESCRIPTION

Aspects of the present disclosure and methods of accomplishing the same may be understood more readily by reference to the detailed description of one or more embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey aspects of the present disclosure to those skilled in the art. Accordingly, description of processes, elements, and techniques that are not necessary to those having ordinary skill in the art for a complete understanding of the aspects and features of the present disclosure may be omitted.

Unless otherwise noted, like reference numerals, characters, or combinations thereof denote like elements throughout the attached drawings and the written description, and thus, descriptions thereof will not be repeated. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

In the detailed description, for the purposes of explanation, numerous specific details are set forth to provide a thorough understanding of various embodiments. It is apparent, however, that various embodiments may be practiced without these specific details or with one or more equivalent arrangements.

It will be understood that, although the terms “zeroth,” “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or component is referred to as being “on,” “connected to,” or “coupled to” another element or component, it can be directly on, connected to, or coupled to the other element or component, or one or more intervening elements or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or component is referred to as being “between” two elements or components, it can be the only element or component between the two elements or components, or one or more intervening elements or components may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, each of the terms “or” and “and/or” includes any and all combinations of one or more of the associated listed items. For example, the expression “A and/or B” denotes A, B, or A and B.

For the purposes of this disclosure, expressions such as “at least one of,” when preceding a list of elements, modify the entire list of elements and do not modify the individual elements of the list. For example, “at least one of X, Y, or Z,” “at least one of X, Y, and Z,” and “at least one selected from the group consisting of X, Y, and Z” may be construed as X only, Y only, Z only, or any combination of two or more of X, Y, and Z, such as, for instance, XYZ, XYY, YZ, and ZZ.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

When one or more embodiments may be implemented differently, a specific process order may be performed differently from the described order. For example, two consecutively described processes may be performed substantially at the same time or performed in an order opposite to the described order.

Any of the components or any combination of the components described (e.g., in any system diagrams included herein) may be used to perform one or more of the operations of any flow chart included herein. Further, (i) the operations are merely examples, and may involve various additional operations not explicitly covered, and (ii) the temporal order of the operations may be varied.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Any of the functionalities described herein, including any of the functionalities that may be implemented with a host, a device, and/or the like or a combination thereof, may be implemented with hardware, software, firmware, or any combination thereof including, for example, hardware and/or software combinational logic, sequential logic, timers, counters, registers, state machines, volatile memories such as dynamic RAM (DRAM) and/or static RAM (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application-specific ICs (ASICs), central processing units (CPUs) including complex instruction set computer (CISC) processors and/or reduced instruction set computer (RISC) processors, graphics processing units (GPUs), neural processing units (NPUs), tensor processing units (TPUs), data processing units (DPUs), and/or the like, executing instructions stored in any type of memory. In some embodiments, one or more components may be implemented as a system-on-a-chip (SoC).

Any of the computational devices disclosed herein may be implemented in any form factor, such as 3.5 inch, 2.5 inch, 1.8 inch, M.2, Enterprise and Data Center Standard Form Factor (EDSFF), NF1, and/or the like, using any connector configuration such as Serial Advanced Technology Attachment (SATA), Small Computer System Interface (SCSI), Serial Attached SCSI (SAS), U.2, and/or the like. Any of the computational devices disclosed herein may be implemented entirely or partially with, and/or used in connection with, a server chassis, server rack, data room, data center, edge data center, mobile edge data center, and/or any combinations thereof.

Any of the devices disclosed herein that may be implemented as storage devices may be implemented with any type of nonvolatile storage media based on solid-state media, magnetic media, optical media, and/or the like. For example, in some embodiments, a storage device (e.g., a computational storage device) may be implemented as an SSD based on not-AND (NAND) flash memory, persistent memory such as cross-gridded nonvolatile memory, memory with bulk resistance change, PCM, and/or the like, or any combination thereof.

Any of the communication connections and/or communication interfaces disclosed herein may be implemented with one or more interconnects, one or more networks, a network of networks (e.g., the Internet), and/or the like, or a combination thereof, using any type of interface and/or protocol. Examples include Peripheral Component Interconnect Express (PCIe), non-volatile memory express (NVMe), NVMe-over-fabric (NVMe-oF), Ethernet, Transmission Control Protocol/Internet Protocol (TCP/IP), Direct Memory Access (DMA) Remote DMA (RDMA), RDMA over Converged Ethernet (ROCE), FibreChannel, InfiniBand, SATA, SCSI, SAS, Internet Wide Area RDMA Protocol (iWARP), and/or a coherent protocol, such as Compute Express Link (CXL), CXL.mem, CXL.cache, CXL.IO and/or the like, Gen-Z, Open Coherent Accelerator Processor Interface (OpenCAPI), Cache Coherent Interconnect for Accelerators (CCIX), and/or the like, Advanced extensible Interface (AXI), any generation of wireless network including 2G, 3G, 4G, 5G, 6G, and/or the like, any generation of Wi-Fi, Bluetooth, near-field communication (NFC), and/or the like, or any combination thereof.

In some embodiments, a software stack may include a communication layer that may implement one or more communication interfaces, protocols, and/or the like such as PCIe, NVMe, CXL, Ethernet, NVMe-oF, TCP/IP, and/or the like, to enable a host and/or an application running on the host to communicate with a computational device or a storage device.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As mentioned above, in the field of computers, a computing system may include a host and one or more memory devices connected to (e.g., communicatively coupled to) the host. The memory devices may be located on the host or may be located remotely from the host. The memory devices of such a computing system may be referred to as a persistent memory system.

Persistent memory systems have revolutionized data storage, offering high-speed, non-volatile memory that bridges the gap between RAM and traditional storage devices. However, ensuring data integrity during power loss events remains a pressing concern. Traditional methods of flushing data from volatile memory to persistent storage during power loss events often take a long time and consume significant power from a substantial power bank, which can be relatively inefficient and result in high costs.

Aspects of some embodiments of the present disclosure provide more efficient and more robust solutions to improve the flush time of persistent memory systems (e.g., CXL-based persistent-memory systems).

In some embodiments of the present disclosure, a host software may preprogram a data-flushing priority table in a device (e.g., in a memory device), associating address regions with priority levels for efficient data flushing (e.g., for efficient data flushing during sudden power loss events). In some embodiments, distinct submission queues for write commands (e.g., non-volatile memory express (NVMe) write commands) may be utilized, with each submission queue being associated with a specific priority level. In some embodiments, when facing an impending power loss or other flush-triggering event, the device may intelligently check the priority table and prioritize the flushing of data based on regions (e.g., storage regions) associated with the data. In some embodiments, data flushing commands may be issued to different submission queues (e.g., to different NVMe submission queues) based on the different priorities associated with the submission queues. In some embodiments, a controller (e.g., an NVMe controller) in a backend storage device (e.g., a solid-state drive (SSD)) may be programmed to serve the submission queues using a priority scheme, such as a strict priority scheme or a weighted round-robin priority scheme to ensure that mission-critical or time-sensitive information is safeguarded (e.g., saved in the non-volatile memory) first and to enhance overall system performance and data reliability.

In some embodiments, a host may send a command (e.g., a host command) to a memory device to specify an address region and a flush-priority level associated with data. In some embodiments, the memory device may provide a data-flush confidence level, as feedback to the host, for each priority region (e.g., for each predefined priority region). In some embodiments, the memory device may initiate data flushing operations based on designated priorities. For example, the memory device may create and maintain distinct submission queues for each flush-priority level. In some embodiments, the device may ensure that higher priority data regions are flushed before lower priority regions.

Aspects of some embodiments of the present disclosure may provide a more precise and efficient way of prioritizing data flushing in persistent memory systems. For example, aspects of some embodiments may reduce data flushing latency, reduce power budgets, reduce costs, improve data reliability, and improve system performance.

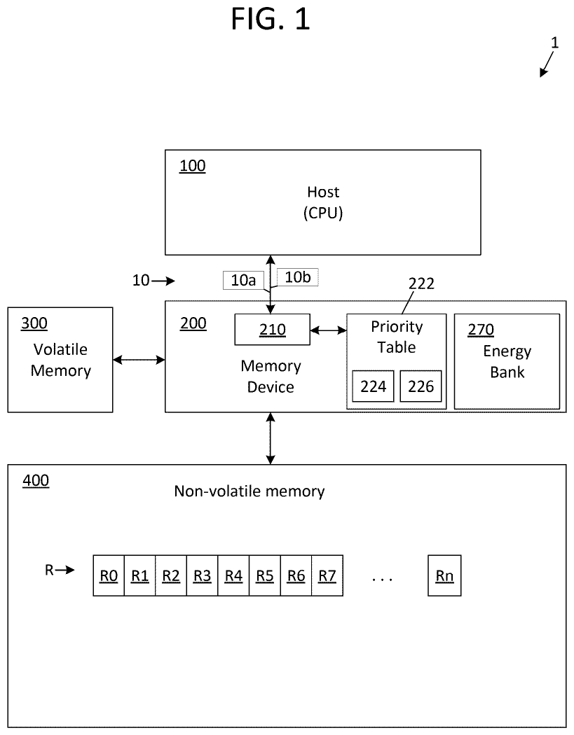

FIG. 1 is a block diagram depicting a system for memory management, according to some embodiments of the present disclosure.

Referring to FIG. 1, the system 1 may include a host 100, a memory device 200 (e.g., a memory controller), a volatile memory 300, and a non-volatile memory 400. In some embodiments, the memory device 200 may include one or more integrated circuits. For example, the memory device 200 may include one or more FPGAs and/or one or more ASICs. A flushing operation may include copying data from the volatile memory 300 to the non-volatile memory 400. The data that is copied to the non-volatile memory 400 may be retrieved from non-volatile memory 400 after a power loss event. For example, the host 100 may cause a flushing operation to be performed by the system 1 based on a server shutdown, based on a PCIe link down, and/or based on an unintentional power loss (e.g., a power failure). That is, the volatile memory 300 may not be capable of preserving data without power being applied to the volatile memory 300. The system 1 may identify data (e.g., “dirty” data) in the volatile memory 300 that has been changed from what is stored in a region R (e.g., a memory region, such as R0 through Rn) of the non-volatile memory 400 associated with the dirty data. The system 1 may perform a flushing operation to update the region R of the non-volatile memory 400 based on the associated dirty data, such that changes made to the data are not lost. For example, the dirty data may be persisted by being copied from the volatile memory 300 to the non-volatile memory 400.

In some embodiments, the memory device 200 may include an energy bank 270 (e.g., a power supply). The energy bank 270 may include energy storage (e.g., power storage) capabilities to allow time for the memory device 200 to perform a flushing operation after a power failure (e.g., via an internal battery). The energy bank 270 may have a limited energy storage capacity allowing for a limited amount of time during which the flushing operation may be performed. The memory device 200 may cause the system 1 to perform the flushing operation in accordance with a priority scheme to save (e.g., to persist) data associated with a higher priority before data associated with a lower priority.

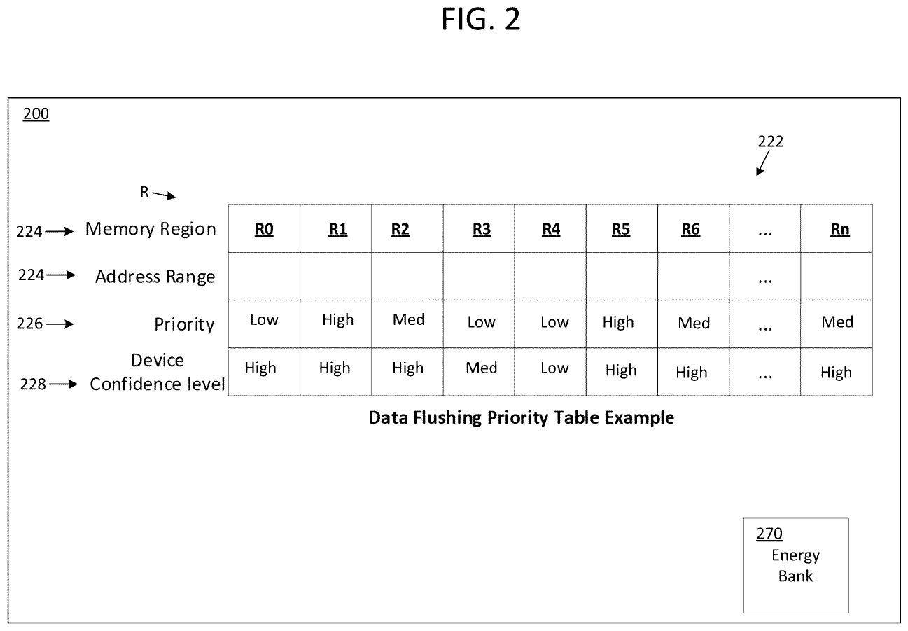

To determine priority levels associated with data in the volatile memory 300, the memory device 200 may refer to a priority table 222 (e.g., a data-flushing priority table), which is discussed in further detail below with reference to FIG. 2. In some embodiments, the priority table 222 may be saved on the memory device 200. The priority table 222 may include location information 224 (e.g., address information and/or region information) and priority information 226. For example, the priority table 222 may include location information 224 for identifying (e.g., for finding) a given region R of the non-volatile memory 400 and/or for identifying data associated with the given region R. The priority table 222 may include priority information 226 for identifying (e.g., for determining) a relative priority (e.g., a priority level) of the data associated with the given region R.

In some embodiments, the host 100 may be enabled to program (e.g., to preprogram) the priority table 222 with the priority information 226. That is, the host 100 may be enabled to associate different priority levels with data corresponding to different regions R of the non-volatile memory 400. The host 100 may be enabled to program and reprogram priority information for data stored in the system 1. The host 100 may include a processing circuit (e.g., a CPU). The host 100 may be communicatively coupled to the memory device 200 via a host interface 210 of the memory device 200. In some embodiments, the host 100 may communicate with the memory device 200 via a communication link using a given protocol (e.g., a given standard). For example, the communication link may include a PCIe link, and the protocol may include a compute express link (CXL) protocol. For example, the host interface 210 may include a CXL endpoint. The host 100 may send a host command 10 to the memory device 200 to program and/or reprogram the priority table 222 with the priority information 226. In some embodiments, the host command 10 may include location information 224 and/or priority information 226 associated with data associated with a given region R of the non-volatile memory 400.

For example, the host 100 may send a first host command 10a and a second host command 10b to the memory device 200. The first host command 10a may include location information 224 and priority information 226 associated with data associated with a first region R1 of the non-volatile memory 400. The second host command 10b may include location information 224 and priority information 226 associated with data associated with a second region R2 of the non-volatile memory 400. The memory device 200 may receive the first host command 10a and the second host command 10b at the host interface 210. The memory device 200 may store the location information 224 and/or the priority information 226 from the host commands 10 (e.g., from the first host command 10a and from the second host command 10b) in the priority table 222.

The host 100 may trigger a flushing operation. For example, a power event (e.g., a planned power event or an unplanned power event) may occur. The host 100 may send a flush request to the memory device 200 based on (e.g., in response to) the power event. Based on the flush request, the memory device 200 may access the priority information 226 associated with the first host command 10a and/or associated with the second host command 10b from the priority table 222. For example, based on the priority table 222, the memory device 200 may determine that data associated with the first region R1 has a different priority (e.g., a higher priority or a lower priority) than data associated with the second region R2.

The memory device 200 may initiate flushing operations from the volatile memory 300 to the non-volatile memory 400 based on the priority information 226 from the priority table 222. For example, the memory device 200 may determine a relative order for writing data to the non-volatile memory 400 based on the priority information 226. For example, the memory device 200 may determine that data associated with the first region R1 has a higher priority than data associated with the second region R2. Based on relative priorities determined from the priority information 226, the memory device 200 may cause data associated with the first region R1 to be written to the non-volatile memory 400 before data associated with the second region R2 is written to the non-volatile memory 400.

In some embodiments, the memory device 200 may monitor an energy level associated with the energy bank 270. The memory device 200 may update the priority table 222 with confidence level information based on whether a given region R may be persisted from the volatile memory 300 to the non-volatile memory 400 given an energy level (e.g., device 200 may have information for determining an amount of energy (e.g., an approximate amount of energy) that is consumed to transfer a given amount of data from the volatile memory 300 to the non-volatile memory 400 and to persist (e.g., store) the given amount of data at the non-volatile memory. Based on the information, the memory device 200 may calculate (e.g., may determine) whether a given amount of energy (e.g., a present energy level) is sufficient for storing data associated with a given region R to the non-volatile memory 400.

FIG. 2 is a table depicting a priority table for use in the system for memory management, according to some embodiments of the present disclosure.

Referring to FIG. 2, the priority table 222 may include information for determining a relative order (e.g., a sequence) for writing data from the volatile memory to the non-volatile memory, based on a flushing operation being triggered. In some embodiments, the location information 224 may include information for identifying a plurality of regions R (e.g., R0-Rn) associated with the non-volatile memory and/or for identifying data associated with the plurality of regions R. The location information 224 may include address information (e.g., address ranges) for identifying or locating a given region R and/or for identifying or locating data associated with the given region R. In some embodiments, the priority information 226 may include priority-level information indicating whether a given region R has a priority level that is higher than, lower than, or equal to another given region R. For example, the host 100 (see FIG. 1) may write an address range to the priority table 222 by indicating a start address for the first region R1 and/or by indicating an end address for the first region R1. In some embodiments, the start address may be represented by a given number of bits (e.g., 64 bits). In some embodiments, the end address may be represented by a given number of bits (e.g., 64 bits). In some embodiments, the host 100 may write a priority level associated with the first region R1 to the priority table 222. In some embodiments, the priority level may be represented by a given number of bits (e.g., 16 bits).

In some embodiments, the memory device 200 may provide (e.g. may write) confidence-level information 228 associated with each region R to the priority table 222. As discussed above, the confidence-level information 228 may be associated with an energy level of the energy bank 270 of the memory device 200. In some embodiments, the memory device 200 may periodically update the confidence-level information 228 for each region R based on periodically checking the energy level of the energy bank 270. In some embodiments, the confidence-level information 228 may be represented by a given number of bits (e.g., 4 bits). In some embodiments, the host 100 may periodically check the confidence-level information 228 and may use the confidence-level information 228 to reprogram the priority information 226. For example, the host 100 may reprogram the priority information 226 based on the confidence-level information 228 to ensure that a given region R can be persisted based on a power event triggering a flushing operation.

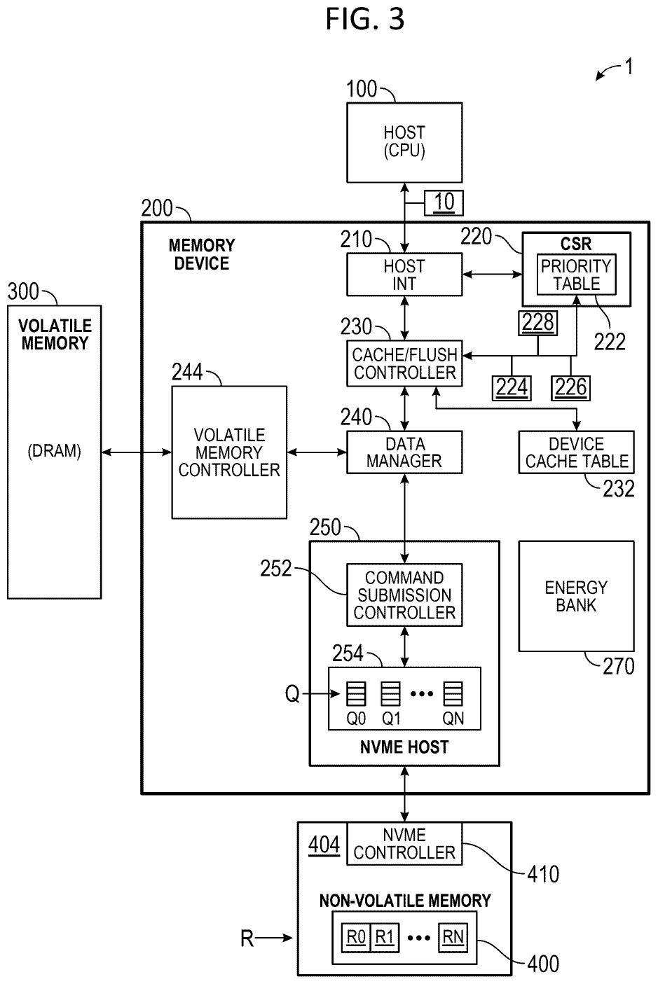

FIG. 3 is a block diagram depicting a system for memory management including a storage device that is separated from a memory device of the system, according to some embodiments of the present disclosure.

Referring to FIG. 3, in some embodiments, the priority table 222 may be accessible to (e.g., exposed to) host software of the host 100 via control and status registers (CSR) 220. For example, the host 100 may preprogram address regions and their respective priority levels based on the CSR 220.

In some embodiments, the memory device 200 may support up to N regions R and N priority levels. The addresses in one region R may be contiguous. The size of each region R may range from zero up to the capacity size of the memory device 200. As discussed above, each region R may have its own start address, end address, and priority level. The host software may program and update the priority table 222 any time and any number of times before a power loss event.

In some embodiments, the memory device 200 may monitor the health of its energy source and determine if one or more of the regions R can be flushed within a current power budget. The memory device 200 may provide confidence level feedback upon completing the memory region flushing in a device confidence level field. The host 100 may read the CSR 220 when the confidence level feedback is ready.

In some embodiments, the CSR 220 may be exposed to the host 100 as I/O-mapped registers utilizing a PCIe base address register (BAR) space or a PCIe/CXL configuration space. In some embodiments, the priority table 222 may be put in a memory-mapped address range and may be accessed by the system software (e.g., by the host 100) as a memory load command or as a memory store command (e.g., as a memory load/store). In some embodiments, the address ranges and their associated data flush priorities may be communicated by the system software (e.g., from the host 100) to the memory device 200 by utilizing PCIe vendor-defined messages. In some embodiments, the regions R and their data flush priorities may be programmed by a baseboard management controller (BMC) using an out of band (OOB) communication channel such as inter-integrated circuit (I2C), system management bus (SMBus), and/or the like.

In some embodiments, the host interface 210 may process transactions (e.g., CXL transactions) from a bus (e.g., a PCIe bus) connecting the host 100 to the memory device 200. For example, the host interface 210 may translate commands received at the host interface 210 to an internal format that may be processed by the memory device 200.

In some embodiments, the memory device 200 may include a cache/flush controller 230, a data manager 240, a volatile memory controller 244 (e.g., a DDR controller) and a volatile memory 300 (e.g., a DRAM), and a command-queue component 254. The memory device 200 may be connected to a non-volatile memory 400 comprising a plurality of regions R. In some embodiments, the non-volatile memory 400 may be separate and distinct from the memory device 200. For example, the memory device 200 may be communicatively connected to the non-volatile memory 400 via a bus (e.g., a PCIe) bus and may communicate with the non-volatile memory 400 via a given protocol (e.g., an NVMe protocol). For example, the non-volatile memory 400 may be located on a separate storage device 404 (e.g., an SSD). In such embodiments, the command-queue component 254 may be associated with a storage host (e.g., an NVMe host) on the memory device 200. The storage host 250 may include command-submission controller 252 to help manage and/or control command queues Q (e.g., Q0 through QN) for writing data from the volatile memory 300 to the non-volatile memory 400. The storage device 404 may include a storage device controller 410 (e.g., an NVMe controller) to help manage and/or control the writing of data to the non-volatile memory 400.

In some embodiments, the cache/flush controller 230 may refer to a cache table 232 (e.g., a device cache table) to save and track data in the volatile memory 300. For example, the cache/flush controller may perform cache hit and/or miss checking. The cache/flush controller 230 may also manage and/or control flushing operations based on the priority table 222. The data manager 240 may help manage and/or control the movement of data between the volatile memory controller 244 and the host 100. The data manager 240 may send write commands to the storage host 250 and may pass priority information to the storage host 250. The volatile memory controller 244 may provide a standard interface for initializing the volatile memory 300 and for performing data transfers with the volatile memory 300.

In some embodiments, upon receiving notice of a flush trigger event (e.g., a power loss event), the cache/flush controller 230 may access the priority table 222 as its initial step. This action may enable the cache/flush controller 230 to initiate data flushing operations with regard (e.g., with precise regard) to the designated priorities (e.g., the designated priorities of a priority scheme). The cache/flush controller 230 may retrieve the location information 224 and/or the priority information 226 from the priority table 222 in response to receiving a flush request from the host 100.

In some embodiments, the cache/flush controller 230 may perform a scan of all entries in the cache table 232 in sequence. During the scan, the cache/flush controller 230 may reference the priority table 222 to determine the priority levels assigned to each dirty entry in the cache table 232. In some embodiments, when transmitting commands to the storage host 250, the cache/flush controller 230 may append the priority information 226 along with the respective location information 224 (e.g., respective addresses), such that data flushing may be performed in alignment with established priorities.

In some embodiments, the cache/flush controller 230 may perform a scan by starting data flushing operations from the region R having the highest priority within the cache table 232. Upon completion of the highest-priority region, the cache/flush controller 230 may dynamically switch its focus to a next lower-priority region. The cache/flush controller 230 may continue this process until all regions R within the cache table 232 are flushed or until the energy from the energy bank meets a given threshold.

In some embodiments, the storage host 250 may assist in moving data from the volatile memory 300 back to the host 100. The storage host 250 may also assist in moving data from the volatile memory 300 to the non-volatile memory 400. For example, the storage host 250 may manage and/or control the command queues Q (e.g., the submission queues) based on priority levels from the priority table 222. For example, a storage host subsystem (e.g., an NVMe host subsystem) of the storage host 250 may assist in performing data flushing based on priority levels.

In some embodiments, an arbitration method (e.g., an arbitration scheme) may be utilized to associate the command queues Q with respective priority levels. For example, a vendor-specific arbitration mechanism, a weighted round-robin arbitration mechanism, a deficit round-robin arbitration mechanism, and/or an urgent priority-class mechanism may be implemented in the storage device controller 410 (e.g., in the NVMe controller) and utilized to associate higher-priority command queues Q with higher-priority regions R. The specific arbitration mechanism may be selected during controller configurations (e.g., upon powering up the storage device 404). In some embodiments, the priority scheme and/or the arbitration scheme of the command queues Q may be configured (e.g., may be determined) by software. For example, the host software may preprogram the arbitration scheme of the command queues through CSRs (e.g., CSRs associated with the storage host 250). The storage device controller 410 may refer to the CSRs to determine the arbitration scheme of the queues. In some embodiments, a command queue Q may utilize a strict priority, wherein all commands in the command queue Q are executed before the storage device controller 410 can serve the other command queues Q. In such embodiments, the storage host subsystem (e.g., the NVMe host subsystem) may place the generated submission queue commands (e.g., the generated NVMe commands) for high priority regions to urgent priority command queues Q. Similarly, in some embodiments, a weighted round-robin mechanism may be used, wherein the storage host subsystem (e.g., the NVMe host subsystem) may assign priority levels (e.g., high, medium, and/or low) of the command queues Q during I/O-queue creation and may control the assigned priority levels via set feature commands. As used herein, “set feature” refers to a part of the NVMe standard. In some embodiments, during the data flush (e.g., during a flushing operation), the storage host subsystem (e.g., the NVMe host subsystem), may determine the priority levels of I/O commands and place the I/O commands into the appropriate command queues Q. In some embodiments, a different vendor-specific priority-multiplexing algorithm may be implemented in the storage device controller 410 (e.g., in the NVMe controller) to prioritize command executions (e.g., to prioritize data writes to the non-volatile memory 400).

In some embodiments, the memory device 200 may maintain and log a status of data flushing. For example, the memory device 200 may record remaining dirty-page numbers that have not yet been written to the non-volatile memory 400, as well as the last cache location that has been flushed. In some embodiments, the memory device 200 may write all the status and statistics into non-volatile memory 400 before power is used up. In some embodiments, the storage host 250 may receive completion notices (e.g., data flush completion notices) from the storage device controller 410. For example, the storage device controller 410 may fetch commands from the command queues Q and process them by writing data associated with the command queues Q to the non-volatile memory 400. The storage device controller 410 may send completion notifications to the memory device 200 when each command has been completed.

In some embodiments, the storage device controller 410 may determine an arbitration method during initialization of the storage device 404 (e.g., during controller configurations or at power up).

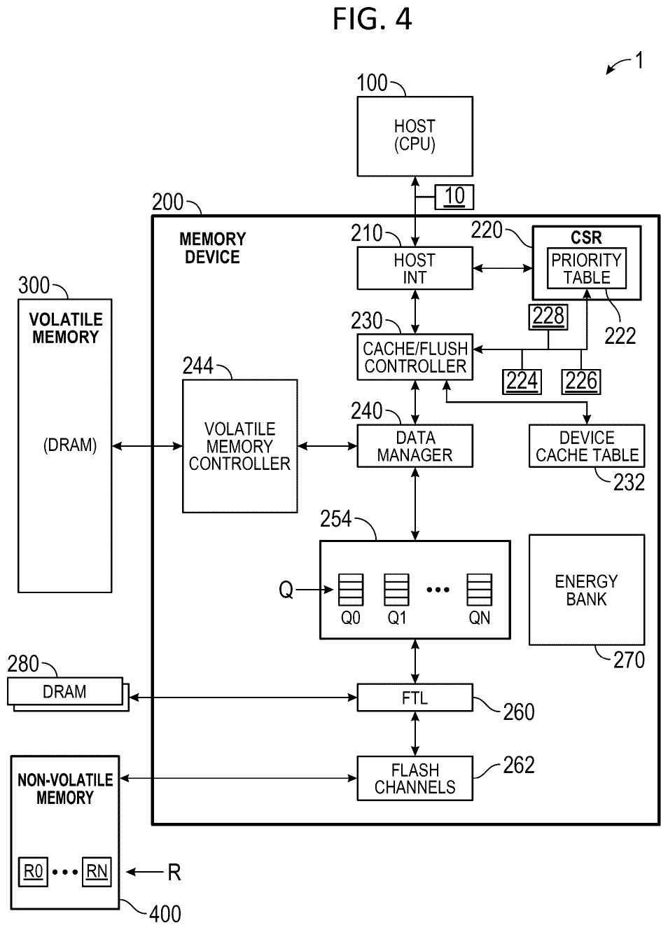

FIG. 4 is a block diagram depicting a system for memory management including an integrated storage and memory device, according to some embodiments of the present disclosure.

Referring to FIG. 4, in some embodiments, the non-volatile memory 400 may be integrated with the memory device 200. In such embodiments, the storage host 250 (e.g., the NVMe host) discussed above with reference to FIG. 3 may be absent from (e.g., may not be provided in) the system 1. For example, the storage host 250 may not be present or it may be present but may not be used to set priorities. In such embodiments, logic of the cache/flush controller 230, logic of a flash translation layer (FTL) 260, and logic of a flash channel may be implemented in a single integrated circuit (e.g., an ASIC) or FPGA controller device. In such embodiments, instead of using a storage host 250, the data manager 240 may directly place dirty data in priority-based command queues Q (e.g., FTL queues or data queues) that are directly accessed by the FTL 260. The logic of the FTL 260 may write the dirty data to the non-volatile memory 400 (e.g., persistent NAND flash media) in order of priority using the logic of the flash channels 262. In other words, in some embodiments, the data manager 240 may communicate directly to the FTL 260, instead of communicating through an intervening NVMe host. In such embodiments, priorities may be determined using one or more of the methods discussed above for associating the command queues Q with respective priority levels. For example, in some embodiments, the data manager 240 may determine priorities using one or more of the methods discussed above for associating the command queues Q with respective priority levels.

In some embodiments, the memory device 200 may be communicatively coupled with a buffer 280 (e.g., a data buffer DRAM) that is separate from or integrated with the volatile memory 300. The buffer 280 may be used by the memory device 200 as an internal data buffer between the volatile memory 300 and the non-volatile memory 400. For example, the volatile memory 300 may be a front-end data caching portion of the system 1, and the buffer 280 may serve as a back-end buffer for copying data from the volatile memory 300 to the non-volatile memory 400.

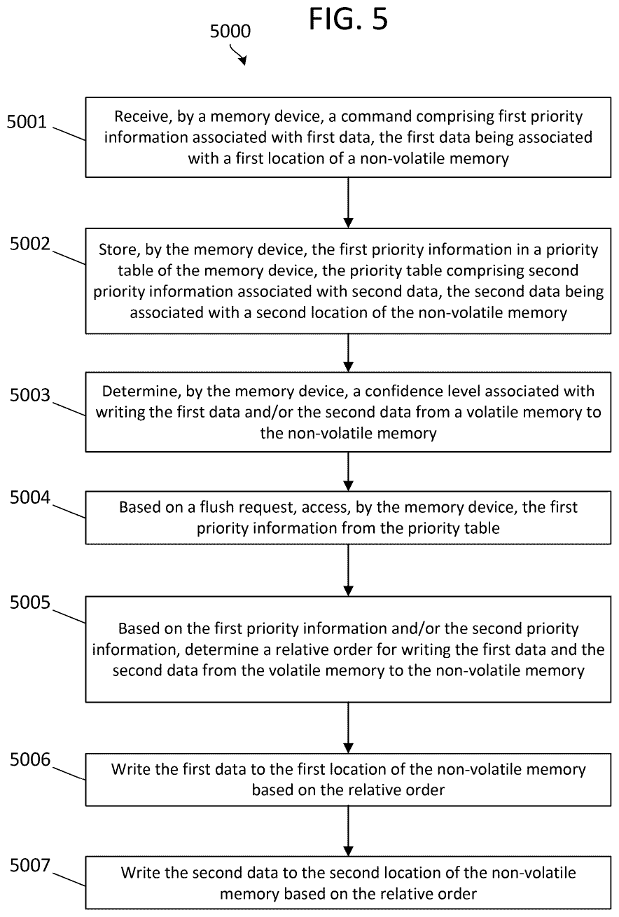

FIG. 5 is a flowchart depicting operations of a method for memory management, according to some embodiments of the present disclosure.

Referring to FIG. 5, the method 5000 may include the following example operations. A memory device 200 (see FIG. 1) may receive a command (e.g., a first host command 10a) comprising first priority information 226 associated with first data, the first data being associated with a first location (e.g., a first given region R) of a non-volatile memory 400 (operation 5001). The memory device 200 may store the first priority information 226 in a priority table 222 of the memory device 200 (operation 5002). The priority table 222 may comprise second priority information 226 associated with second data associated with a second location (e.g., a second given region R) of the non-volatile memory 400 (operation 5002). The memory device 200 may determine a confidence level associated with writing the first data and/or the second data from a volatile memory 300 to the non-volatile memory 400 (operation 5003). Based on a flush request, the memory device 200 may access the first priority information 226 from the priority table 222 (operation 5004). Based on the first priority information 226 and/or based on the second priority information 226, the memory device 200 may determine a relative order for writing the first data and the second data from the volatile memory 300 to the non-volatile memory 400 (operation 5005). The memory device 200 may write the first data to a first location (e.g., the first given region R) of the non-volatile memory 400 based on the relative order (operation 5006). The memory device 200 may write the second data to the second location (e.g., the second given region R) of the non-volatile memory 400 based on the relative order.

Accordingly, aspects of some embodiments of the present disclosure may provide improvements to memory management by providing a host-programmable priority scheme for data flushing that allows for flexible and efficient data flushing.

Example embodiments of the disclosure may extend to the following statements, without limitation:

Statement 1. An example method includes: receiving, by a memory device, a host command including first priority information associated with first data, the first data being associated with a first location of a non-volatile memory, storing, by the memory device, the first priority information in a priority table of the memory device, based on a flush request, accessing, by the memory device, the first priority information from the priority table, and based on the first priority information, writing, by the memory device, the first data from a volatile memory to the non-volatile memory.

Statement 2. An example method includes the method of statement 1, wherein the memory device includes a host interface configured to receive the host command from a host via a first protocol, and the host command includes first location information for identifying the first location of the non-volatile memory.

Statement 3. An example method includes the method of any of statements 1 and 2, further including receiving, by the memory device, the flush request based on a power event.

Statement 4. An example method includes the method of any of statements 1-3, wherein the memory device includes a cache controller for initiating, based on the flush request, flushing operations according to priority levels in the priority table.

Statement 5. An example method includes the method of any of statements 1-4, further including based on the flush request, accessing, by the memory device, address information associated with the first priority information.

Statement 6. An example method includes the method of any of statements 1-5, wherein the priority table includes second priority information associated with second data, the second data being associated with a second location of the non-volatile memory, the second priority information being different from the first priority information, and the method further includes, based on at least one of the first priority information or the second priority information, determining a relative order for writing the first data and the second data from the volatile memory to the non-volatile memory.

Statement 7. An example method includes the method of any of statements 1-6, further including receiving, by a first queue associated with a first priority level, a first device command associated with writing the first data from the volatile memory to the non-volatile memory, and receiving, by a second queue associated with a second priority level, a second device command associated with writing second data from the volatile memory to the non-volatile memory.

Statement 8. An example method includes the method of any of statements 1-7, wherein the first queue and the second queue are associated with at least one of a priority scheme or an arbitration scheme configured by software.

Statement 9. An example method includes the method of any of statements 1-8, wherein the memory device prioritizes the writing of the first data over writing second data from the volatile memory to the non-volatile memory based on the first data being associated with a higher priority level than the second data.

Statement 10. An example method includes the method of any of statements 1-9, wherein the priority table includes confidence level information that is determined based on an energy level associated with the memory device.

Statement 11. An example method includes the method of statements 10, wherein the confidence level information is determined based on an amount of energy that is consumed for storing the first data to the non-volatile memory, and the first priority information is determined based on the confidence level information.

Statement 12. An example device for performing the method of any of statements 1-11 includes a processing circuit configured to perform the method of any of statements 1-11.

Statement 13. An example system for performing the method of any of statements 1-11 includes a volatile memory, a non-volatile memory, and a processing circuit configured to perform the method of any of statements 1-11.

While embodiments of the present disclosure have been particularly shown and described with reference to the embodiments described herein, it will be understood by those of ordinary skill in the art that various changes in form and details may be made therein without departing from the spirit and scope of the present disclosure as set forth in the following claims and their equivalents.

What is claimed is:

1. A method for memory management, the method comprising:
receiving, by a memory device, a host command comprising first priority information associated with first data, the first data being associated with a first location of a non-volatile memory;
storing, by the memory device, the first priority information in a priority table of the memory device;
based on a flush request, accessing, by the memory device, the first priority information from the priority table; and
based on the first priority information, writing, by the memory device, the first data from a volatile memory to the non-volatile memory.

2. The method of claim 1, wherein:
the memory device comprises a host interface configured to receive the host command from a host via a first protocol; and
the host command comprises first location information for identifying the first location of the non-volatile memory.

3. The method of claim 1, further comprising receiving, by the memory device, the flush request based on a power event.

4. The method of claim 1, wherein the memory device comprises a cache controller for initiating, based on the flush request, flushing operations according to priority levels in the priority table.

5. The method of claim 1, further comprising:
based on the flush request, accessing, by the memory device, address information associated with the first priority information.

6. The method of claim 1, wherein:
the priority table comprises second priority information associated with second data, the second data being associated with a second location of the non-volatile memory, the second priority information being different from the first priority information; and
the method further comprises, based on at least one of the first priority information or the second priority information, determining a relative order for writing the first data and the second data from the volatile memory to the non-volatile memory.

7. The method of claim 1, further comprising:
receiving, by a first queue associated with a first priority level, a first device command associated with writing the first data from the volatile memory to the non-volatile memory; and
receiving, by a second queue associated with a second priority level, a second device command associated with writing second data from the volatile memory to the non-volatile memory.

8. The method of claim 7, wherein the first queue and the second queue are associated with at least one of a priority scheme or an arbitration scheme configured by software.

9. The method of claim 1, wherein the memory device prioritizes the writing of the first data over writing second data from the volatile memory to the non-volatile memory based on the first data being associated with a higher priority level than the second data.

10. The method of claim 1, wherein the priority table comprises confidence level information that is determined based on an energy level associated with the memory device.

11. The method of claim 10, wherein:
the confidence level information is determined based on an amount of energy that is consumed for storing the first data to the non-volatile memory; and
the first priority information is determined based on the confidence level information.

12. A memory device comprising:
a processing circuit configured to perform:
receiving a host command comprising first priority information associated with first data, the first data being associated with a first location of a non-volatile memory;
storing the first priority information in a priority table of the memory device;
based on a flush request, accessing the first priority information from the priority table; and
based on the first priority information, writing the first data from a volatile memory to the non-volatile memory.

13. The memory device of claim 12, further comprising a host interface configured to receive the host command from a host via a first protocol,
wherein the host command comprises first location information for identifying the first location of the non-volatile memory.

14. The memory device of claim 12, wherein the processing circuit is configured to perform receiving, by the memory device, the flush request based on a power event.

15. The memory device of claim 12, wherein the memory device comprises a cache controller for initiating, based on the flush request, flushing operations according to priority levels in the priority table.

16. The memory device of claim 12, wherein the processing circuit is configured to perform, based on the flush request, accessing address information associated with the first priority information.

17. The memory device of claim 12, wherein:
the priority table comprises second priority information associated with second data, the second data being associated with a second location of the non-volatile memory, the second priority information being different from the first priority information; and
the processing circuit is configured to perform, based on at least one of the first priority information or the second priority information, determining a relative order for writing the first data and the second data from the volatile memory to the non-volatile memory.

18. The memory device of claim 12, wherein the processing circuit is configured to perform:
receiving, by a first queue associated with a first priority level, a first device command associated with writing the first data from the volatile memory to the non-volatile memory; and
receiving, by a second queue associated with a second priority level, a second device command associated with writing second data from the volatile memory to the non-volatile memory.

19. The memory device of claim 18, wherein the first queue and the second queue are associated with at least one of a priority scheme or an arbitration scheme configured by software.

20. A system comprising:
a volatile memory;
a non-volatile memory; and
a processing circuit configured to perform:
receiving a host command comprising first priority information associated with first data, the first data being associated with a first location of the non-volatile memory;
storing the first priority information in a priority table of a memory device associated with the processing circuit;
based on a flush request, accessing the first priority information from the priority table; and
based on the first priority information, writing the first data from the volatile memory to the non-volatile memory.
